(19) United States
(12) Patent Application Publication
(10) Pub. No.: US 2009/0029715 A1
(43) Pub. Date: Jan. 29, 2009

(54) Method For Determining The Distance Of A Mobile Communication Terminal From Mobile Radio Base Stations, And Mobile Communication Terminal

(76) Inventor: Bernd Burchardt, Stuhr-Brinkum (DE)

Correspondence Address: STAAS & HALSEY LLP, SUITE 700, 1201 NEW YORK AVENUE, N.W., WASHINGTON, DC, 20005, US

(21) Appl. No.: 11/658,995

(22) PCT Filed: Mar. 22, 2006
(86) PCT No.: PCT/DE06/00524

§ 371 Date: May 2, 2008

(51) Int. Cl. H04W 84/00

(52) U.S. Cl. 455/456.1

(57) ABSTRACT

In contrast to the related art, in which the distance value is calculated exclusively from the timing advance value, the first mobile radio base station or the mobile communication terminal additionally calculates a second distance value, which is more accurate in comparison with the above distance value but is multi-valued, from the following parameters: a first carrier frequency signal and a second carrier frequency signal with a fixed frequency offset, an initial phase relation at the transmitting site of the first carrier frequency signal with respect to the second carrier frequency signal, and a measured phase relation (MP1) at the receiving site of the first carrier frequency signal with respect to the second carrier frequency signal. The distance between the mobile communication terminal and the first mobile radio base station is determined more precisely by comparing the two distance values. The method can be extended to a plurality of mobile radio base stations. In combination with location data of the mobile radio base stations, it is also possible to determine a location of the mobile communication terminal.

### CROSS REFERENCE TO RELATED APPLICATIONS

This application is based on and hereby claims priority to Application No. PCT/DE2006/000524 filed on Mar. 22, 2006, the contents of which are hereby incorporated by reference.

### BACKGROUND

The invention relates to a method for determining the distance of a mobile communication terminal from one or more mobile radio base stations, and to a mobile communication terminal.

Mobile communication terminals have been used widely for many years. They enable a moving subscriber who carries a mobile communication terminal (mobile phone) with him to set up a telecommunication link to another subscriber, or to be called by a subscriber, from almost all closely settled points on the land surface of the earth. At present, the mobile radio network which was specified in accordance with the GSM (Global System for Mobile Communications) standard has the widest coverage, and most of the mobile communication terminals in use utilize the GSM standard. Other mobile GSM communication terminals are so- called GSM radio modules, GSM PCMCIA cards, GSM radio modems etc.

Among other things, the network architecture of the GSM standard defines a mobile radio transmitting system, also called base station subsystem, which, in turn, includes base transceiver stations and associated base station controllers, and a switching system. The structure and operation of cellular networks, particularly of the GSM mobile radio system, are known and described in detail in many publications so that they do not require any further explanation here.

The location of a mobile communication terminal can be determined, for example, by a method in which an additional GPS receiver is integrated in the mobile communication terminal, which evaluates a plurality of information items relevant for determining the location and provided by satellites. With the aid of corresponding digital map material, the location can be determined with an inaccuracy of only a few square meters, which is due to measuring errors.

In a further method, the distance of a mobile communication terminal from mobile radio base stations and also its location, if a plurality of mobile radio base stations cooperate in the method, can be determined by using signaling information exclusively transmitted within the GSM mobile radio network. In this method, additional components (GPS receivers) can be omitted. These signaling information items are time offsets, also known as timing advance values to the experts, and preferably location data of the mobile radio base stations.

Since the GSM mobile radio network also uses a time division multiplex method for radio resource distribution, apart from the frequency division multiplex method, and corresponding transmitting and receiving timeslots are allocated to the mobile communication terminal by the current mobile radio base station, radio signals transmitted must arrive at the respective receiver in the receiving time slot provided. To ensure that this happens, the transmitting times of the radio signals to be transmitted are typically advanced in time so that these transmitted radio signals arrive at the correct time in the receiver. The farther away the mobile communication terminal is from the mobile radio base station, the sooner it must send out the radio signals. The timing advance values are regularly determined by the mobile radio base station in the GSM mobile radio network and signal to the mobile communication terminal, the GSM mobile radio network providing 63 different discrete timing advance values and the timing advance value being increased for each 550 meters distance of the mobile communication terminal from the mobile radio base station. Accordingly, these signaling information items from only one mobile radio base station can be used for determining the distance of the mobile communication terminal from this mobile radio base station with a radial distance inaccuracy of 550 meters.

Apart from the distance between the mobile communication terminal and mobile radio base station which, as described, is determined from the signal parameter “time”, the direction (the angle) of the signals sent out by the mobile communication terminal to the mobile radio base station can also be determined as further signal parameter in the mobile radio base station. This is achieved by an arrangement of a plurality of antennas in the mobile radio base station and measuring phase differences of received signals at the various antennas and field strength measurements within the antenna device used.

If the two signal parameters “time” and “angle of reception” are evaluated, the location of the mobile communication terminal can be determined with an inaccuracy of a few hundred square meters in the current GSM.

Mobile communication terminals communicate not only with a signal mobile radio base station but also send out and receive signaling information from and to, respectively, a plurality of adjacent mobile radio base stations in time slots provided for this purpose.

If only the signal parameter “time” is measured, and not the signal parameter “angle of reception”, the distance of the mobile communication terminal from three mobile radio base stations can be determined by evaluating the abovementioned signaling information items from the three mobile radio base stations and the location of the mobile communication terminal can be determined by using location data of the three mobile radio base stations. The location of the mobile communication terminal lies within a concentric ring around the first mobile radio base station, within a concentric ring around the second mobile radio base station and within a concentric ring around the third mobile radio base station. If the three rings intersect, the location of the mobile communication terminal is within the area of overlap of the three concentric rings.

The method can be made more accurate by using signaling information items from further mobile radio base stations, particularly when there are disturbances in the radio transmission of the signaling information items to the first, second and/or third mobile radio base station.

In summary, the distance of the mobile communication terminal from mobile radio base stations or, respectively, the location of the mobile communication terminal within the GSM mobile radio network can only be determined with relatively great inaccuracies due to the system. It is not possible to determine where the mobile communication terminal is located within an area of several hundred square meters.

### SUMMARY

It is one possible object, therefore, to determine the distance of a mobile communication terminal from a mobile radio base station and possibly other mobile radio base stations, and a mobile communication terminal by which the distance of the mobile communication terminal from the mobile radio base station and possibly the further mobile radio base stations can be determined more precisely.

The inventor proposes a method for determining the distance of a mobile communication terminal from a first mobile radio base station in a mobile radio network, wherein, for this purpose, the following quantities are compared with one another with reference to the communication between the mobile communication terminal and the first mobile radio base station:
a. a first distance value calculated from a timing advance value, and
b. a multi-valued second distance value, which is more accurate in comparison with the first distance value, calculated from
   aa) a frequency offset between a first carrier frequency signal and a second carrier frequency signal,
   bb) an initial phase relation at the transmitting site of the first carrier frequency signal with respect to the second carrier frequency signal,
   cc) a measured phase relation at the receiving site of the first carrier frequency signal with respect to the second carrier frequency signal.

The object is also achieved by a mobile communication terminal for carrying out the method described in the preceding paragraph.

The determination of the distance of the mobile communication terminal from a mobile radio base station and possibly other mobile radio base stations can be made more accurate by the method and the mobile communication terminal.

The quantities are calculated and/or compared in the mobile communication terminal. This relieves the mobile radio network from the transmission of the calculated and/or compared quantities.

In a furthermore advantageous manner, the timing advance value and the initial phase relation are signaled to the mobile communication terminal by the first mobile radio base station and the measured phase relation is determined in the mobile communication terminal. This makes it possible to integrate the calculation and/or the comparison of the quantities into the existing GSM system in a simple manner.

In a furthermore advantageous manner as alternative to the previous paragraph, the initial phase relation is determined by the mobile communication terminal and the measured phase relation is determined in the first mobile radio base station and the timing advance value and the measured phase relation are signaled to the mobile communication terminal by the first mobile radio base station. Thus, the calculation and/or the comparison of the quantities can be flexibly divided between the mobile communication terminal and components of the mobile radio network.

In a furthermore advantageous manner alternative to the third preceding paragraph, the quantities are calculated and/or compared in a component of the mobile radio network. As a result, the calculation and/or comparison of the quantities can take place even when the user of the mobile communication terminal is not interested in distance determinations at all.

In an advantageous development with respect to the preceding paragraph, the particular distance determined or the parameter from which the distance can be derived is signaled to the mobile communication terminal by the first mobile radio base station. This mainly relieves the mobile communication terminal from computing operations with respect to the method described.

In a furthermore advantageous manner, the method is correspondingly extended to other mobile radio base stations in that other timing advance values, frequency offsets, initial phase relations, measured phase relations and first and second carrier frequency signals and first and second distance values to be calculated with respect to the distance determination with reference to the respective further mobile radio base station are compared and/or calculated. As a result, a distance determination of the mobile communication terminal from one or more mobile radio base stations can also take place if the signal transmission from the first mobile radio base station is disturbed.

The method is advantageously developed in such a manner that the quantities are combined with location data of the first mobile radio base station and possibly other mobile radio base stations for determining the location of the mobile communication terminal. The location determination of the mobile communication terminal can be used for other location-based mobile radio services.

The method described in the preceding paragraph is advantageously developed in such a manner that the location found is combined with stored other geographic data and the location is displayed on maps displayed on a display unit of the mobile communication terminal. As a result, the user of the mobile communication terminal can recognize his own location in the geographic map system familiar to him and can also use location-based mobile radio services.

The method of the preceding or the two preceding paragraphs is advantageously developed by the location found being combined with other data from service providers in order to offer and/or utilize services such as rescue services (e-call), motion profiles, position-related advertising or news etc. It is thus possible to utilize a multiplicity of services.

### BRIEF DESCRIPTION OF THE DRAWINGS

These and other objects and advantages will become more apparent and more readily appreciated from the following description of the preferred embodiments, taken in conjunction with the accompanying drawings of which:

FIG. 1 shows a mobile communication terminal according to one potential embodiment of the invention which exchanges signaling messages for distance and location determination with a first, a second and a third mobile radio base station,

FIG. 2 shows the result of the method for distance determination from a first and a second distance value, and

FIG. 3 shows the result of the method for distance and location determination after evaluation of signaling messages exchanged with a first, a second and a third mobile radio base station.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

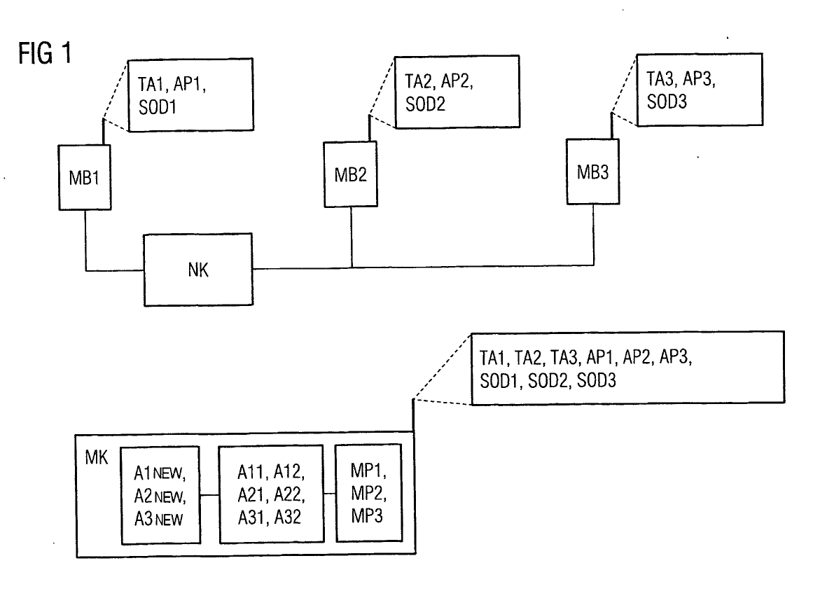

FIG. 1 shows a mobile communication terminal MK according to one potential embodiment of the invention which receives from a first, a second and a third mobile radio base station MB1, MB2, MB3, which are in each case connected to a network component NK such as a mobile radio base station controller or a switching system, signaling messages TA1, TA2, TA3, AP1, AP2, AP3, SOD1, SOD2, SOD3 for determining the distance and location of the mobile communication terminal MK from the first, second and third mobile radio base station MB1, MB2, MB3 and processes the received signaling messages TA1, TA2, TA3, AP1, AP2, AP3, SOD1, SOD2, SOD3 further.

Initially, however, the measuring principle for determining distance by transmitted signaling information TA1, AP1, SOD1, of the first mobile radio base station MB1 will be explained and its evaluation by the mobile communication terminal MK will be demonstrated.

Signaling information sent out by a first mobile radio base station MB1 is modulated onto predetermined carrier frequencies TFS11, TFS12 of the GSM mobile radio network. The radio wave propagates at the speed of light, the wavelength being calculated from the quotient of the light velocity and carrier frequency TFS11, TFS12. Depending on the distance of the receiver from the transmitter, the phase of the received signal (phase angle) is between 0 and 2π or, respectively, (0° and 360°).

To increase the accuracy of the distance determination, it is necessary to measure the phase difference angle at two different carrier frequencies TFS11, TFS12. Since the GSM mobile radio network already uses the frequency hopping method with discrete carrier frequency intervals of 200 kHz, no further frequency algorithms have to be implemented for this measuring method in the GSM mobile radio network.

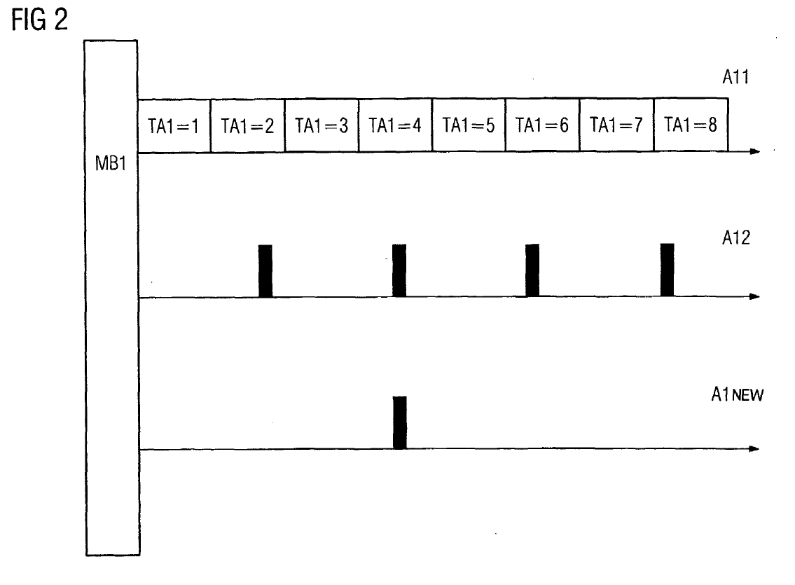

At a first carrier frequency spacing, called frequency offset in the further text, of 200 kHz between a first carrier frequency signal TFS11 and a second carrier frequency signal TFS12, a first measured phase relation MP1 is determined in the mobile communication terminal MK. This first measured phase relation MP1 is the phase difference angle at the receiving site, in this case at the receiver of the mobile communication terminal MK, between the first carrier frequency signal TFS11 received and the second carrier frequency signal TFS12 received. With respect to the distance determination of the mobile communication terminal MK, the following consideration must be noted, the result of which is illustrated in FIG. 2, the distance from the first mobile radio base station MB1 in each case increasing in the direction of the arrow in FIG. 2.

At a first frequency offset of 200 kHz between the first carrier frequency signal TFS11 and the second carrier frequency signal TFS12, it is found that the same value for the first measured phase relation MP1 recurs only after 1500 meters of radial distance change between the first mobile radio base station MB1 and the mobile communication terminal MK. This is represented by the distance between the adjacent black bar on the center arrow in FIG. 2. The relationship shown is obtained from taking into consideration the quotient of the velocity of light and the first frequency offset. If it is then considered that with electronic components such as frequency mixer, frequency converter and phase detector circuits used today in mobile radio base stations and mobile communication terminals, first measured phase relations MP1 of about 50, can be resolved, the resolvable radial distance between first mobile radio base station MB1 and mobile communication terminal MK is reduced to 5°/360°* 1500 meters=20 meters. With improved electronic components, even first measured phase relations MP1 of 0.57° can be expected which would lead to radially resolvable distances of about 2 meters and thus very accurate distance determinations. The system-related inaccuracies in the distance determination are symbolized by the width of the bars on the center arrow in FIG. 2. In summary, therefore, an accurate, but multi-valued distance value A12, called second (multi-valued) distance value A12 in the further text, can be calculated by this method.

Using the method hitherto described, it is thus possible to determine that the mobile communication terminal MK must be located within one of a plurality of rings, lying about the first mobile radio base station MB1, with a ring width of about 20 meters, the individual rings having a radial distance of 1500 meters from one another.

By additionally using the method for distance determination of the mobile communication terminal MK, known from the GSM standard in accordance with the related art, with the aid of the evaluation of the first timing advance value TA1 described in the introduction, radial distance determinations with a radial inaccuracy of 550 meters geared to the system are possible. In FIG. 2, the width of the respective box with TA1=1, TAI=2, etc. on the top arrow is intended to symbolize 550 meters in each case. In this manner, a distance value A11 can be calculated which is called first distance value A11 in the further text.

If the two methods for distance determination are combined, the mobile communication terminal MK can determine which second (multi-value) distance value A12 is the correct one by comparing the first distance value A11 and the second (multi-value) distance value A12. In this exemplary embodiment the first distance value A11 is calculated from the timing advance value TA1=4. The second distance value A12, symbolized by the second bar from the left, is the distance value which is to be correlated with the first distance value A11. The evaluation of the first distance value A11 and the second distance value A12 thus results in an unambiguous accurate new distance value A1NEW. This is represented by the bars on the bottom arrow in FIG. 2. The mobile communication terminal MK is thus located in a “narrow” ring around the first mobile radio base station MB1.

If the first mobile radio base station MB1 additionally obtains direction information as described as signal parameter “angle of reception” in the introductory part, from the signals received from the mobile communication terminal MK, the area of location of the mobile communication terminal MK can be narrowed down further.

By evaluating first location data SOD1 of the first mobile radio base station MB1, such as e.g. location in the geographic reference system (geographic longitude, geographic latitude etc.), the mobile communication terminal MK can determine its distance within a ring of about 20 meters in the geographic reference system.

Naturally, the method described above only functions if the first carrier frequency signal TFS11 and the second carrier frequency signal TFS12 were sent out by the first mobile radio base station MB1 with a known first initial phase relation AP1 (phase difference angle between the first carrier frequency signal TFS11 and the second carrier frequency signal TFS12 at the time of transmission) at the transmitting site. This first initial phase relation AP1 is firmly predetermined in the GSM mobile radio network or is signaled to the mobile communication terminal MK, if the first initial phase relation AP1 is variable or differs from case to case, by the first mobile radio base station MB1, as is the first frequency offset used. Within the GSM mobile radio network, the first mobile radio base station MB1 simultaneously sends, on different frequency channels, apart from the payload data, also signaling information which is used by a mobile communication terminal MK, for example for frequency correction. Since the mobile communication terminal MK has a main oscillator with sufficient short-term stability, the measurement in which the first measured phase relation MP1 is determined can take place within a predetermined GSM time frame (TDMA).

If payload data are transmitted by the first carrier frequency signal TFS11, a path must be coupled out in the GSM receiver for receiving the second carrier frequency signal TFS12. As an alternative, a corresponding algorithm could be programmed in so-called software-defined radios.

The distance determination of the mobile communication terminal MK can be extended if the method is additionally performed with further mobile radio base stations MB2, MB3. The disclosure comprises both the extension by a second mobile radio base station MB2, the extension by a second and third mobile radio base station MB2, MB3 and by fourth, fifth and further mobile radio base stations.

In the text which follows, the expansion of the method by three mobile radio base stations MB1, MB2, MB3 will be explained. In this arrangement, the mobile communication terminal MK evaluates, in addition to that described in the preceding text with respect to the communication with the first mobile radio base station MB1, a second timing advance value TA2 notified by the second mobile radio base station MB2, and a third timing advance value TA3 notified by the third mobile radio base station MB3, and receives a first carrier frequency signal TFS21 and a second carrier frequency signal TFS22 with a second known frequency offset from the second mobile radio base station MB2 and receives a first carrier frequency signal TFS31 and a second carrier frequency signal TFS32 with a known third frequency offset from the third mobile radio base station MB3. The first carrier frequency signal TFS21 was sent out by the second mobile radio base station MB2 with a known second initial phase relation AP2 with respect to the second carrier frequency signal TFS22, and the second initial phase relation AP2 at the transmitting site, i.e. at the transmitter of the second mobile radio base station MB2 if signaled to the mobile communication terminal MK. The first carrier frequency signal TFS31 was sent out by the third mobile radio base station MB3 with a known third initial phase relation AP3 with respect to the second carrier frequency signal TFS32 and the third initial phase relation AP3 at the transmitting site, i.e. at the transmitter of the third mobile radio base station MP3, is also signaled to the mobile communication terminal MK.

The mobile communication terminal MK determines the second measured phase relation MP2 of the first carrier frequency signal TFS21, sent out by the second mobile radio base station MB2 with respect to the second carrier frequency signal TFS22 sent out by the second mobile radio base station MB2 at the receiving site, i.e. at the receiver of the mobile communication terminal MK, and determines the third measured phase relation MP3 of the first carrier frequency signal TFS31 sent out by the third mobile radio base station MB3 with respect to the second carrier frequency signal TFS32 sent out by the third mobile radio base station MB3, also at the receiving site, i.e. at the receiver of the mobile communication terminal MK.

The mobile communication terminal can thus calculate a first distance value A11 and a second distance value A12 with reference to the first mobile radio base station MB1, a first distance value A21 and a second distance value A22 with reference to the second mobile radio base station MB2 and a first distance value A31 and a second distance value A32 with reference to the third mobile radio base station MB3. By comparing the two distance values A11, A12, the two distance values A21, A22 and the two distance values A31, A32, new distance values Al NEW with reference to the first mobile radio base station MB1, A2NEW with reference to the second mobile radio base station MB2, and A3NEW with reference to the third mobile radio base station MB3, can be determined precisely in the mobile communication terminal MK.

Independently of whether the first, second and third mobile radio base station MB1, MB2, MB3 use direction-independent or direction-determining received signal evaluating units, only a single area of overlap results as location area for the mobile communication terminal MK formed from three concentric rings, a first one around the first mobile radio base station MB1, a second one around the second mobile radio base station MB2 and a third one around the third mobile radio base station MB3.

The mobile communication terminal MK can determine its location within the single area of overlap in a geographic reference system by additionally evaluating first location data SOD1 of the first mobile radio base station MB1, which the latter conveys to the mobile communication terminal MK, of second location data SOD2 of the second mobile radio base station MB2, which the latter conveys to the mobile communication terminal MK, and of third location data SOD3 of the third mobile radio base station MB3 which the latter conveys to the mobile communication terminal MK.

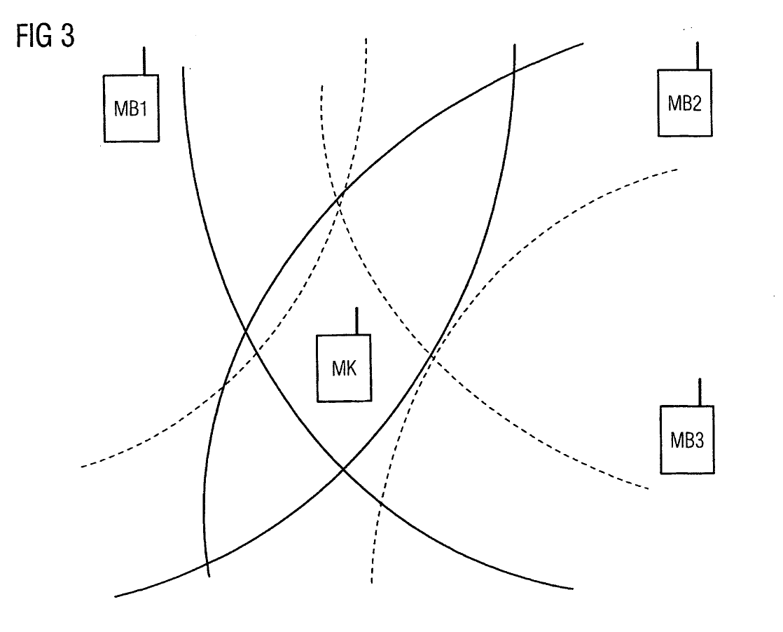

For further explanation, FIG. 3 shows circular segment-like ring sections around the respective mobile radio base station MB1, MB2, MB3, the dashed line in each case representing the inner boundary line and the continuous line in each case representing the outer boundary line. The mobile communication terminal MK then determines its location as lying within the intersecting three rings.

Using current electronic components, by which measured phase relations MP1, MP2, MP3 of about 50 can be resolved, the location can be determined within an area of about 20 meters * 20 meters. Using the improved electronic components by which measured phase relations MP1, MP2, MP3 of about 0.570 can be expected, the location can be defined more precisely within an area of 2 meters * 2 meters.

It is possible to extend the method correspondingly to further mobile radio base stations and further initial phase relations, measured phase relations, timing advance values and location data to be evaluated with respect to distance and location determination, e.g. in order to compensate for any disturbances of the radio links between the mobile communication terminal MK and the first, second and/or third mobile radio base station MB1, MB2, MB3.

The method would also easily provide for the coupling with location-based mobile radio services known from the related art, without having to integrate the GPS receiver in the mobile communication terminals MK. In this arrangement, the location found is combined with other data from service providers in order to offer and/or utilize, e.g. rescue services (e-call), motion profiles, position-related advertising or news and other services.

To increase user friendliness, the location data found are combined with stored other geographic data and the location of the mobile communication terminal MK is indicated on maps displayed on a display unit of the mobile communication terminal MK, e.g. in geographic longitudinal and latitudinal degrees, or road maps.

In principal, all parameters needed are already provided by the GSM mobile radio system. It only requires program adaptations of the mobile radio base stations MB1, MB2, MB3 and of the mobile communication terminal MK in order to be able to utilize the method in its entire possibilities.

In the previous description, the mobile communication terminal MK evaluates the received first carrier frequency signals TFS11, TFS21, TFS31, second carrier frequency signals TFS12, TFS22, TFS32, timing advance values TA1, TA2, TA3 and possibly location data SOD1, SOD2, SOD3 and determines from these the respective distances and its location.

However, the distance and location determination of the mobile communication terminal can also be carried out by the mobile radio network (not shown here). For this purpose, a network component is connected to the first, second and third mobile radio base station. The method then proceeds virtually as a mirror image (communication terminal transmits signaling messages, mobile radio base stations receive signaling messages) to the above representation so that it will only be explained briefly. In contrast to the above example, the mobile communication terminal now determines timing advance values to be maintained and conveys these to the first, second, third and/or other mobile radio base stations. The mobile communication terminal sends first carrier frequency signals and second carrier frequency signals with known frequency offsets and initial phase relations and signals the initial phase relations to the mobile radio base station/s. The mobile radio base stations or the network components determine the measured phase relations, evaluate them, and, taking into consideration evaluated timing advance values, determine the current distance of the mobile communication terminal from the first, second and/or third mobile radio base station.

The network component can determine the location of the mobile communication terminal by additionally evaluating location data of the first, second and/or third mobile radio base station. The location determined for the mobile communication terminal can be conveyed by the network component via one of the mobile radio base stations to the mobile communication terminal where the location found is combined with stored other geographic data and is displayed on displayed maps on a display unit of the mobile communication terminal.

Here, too, intermediate solutions are conceivable. Without departing from the concept proposed here, it can be arranged virtually arbitrarily which values are determined, calculated, compared and/or signaled to the other partner by which partner (mobile communication terminal or mobile radio base station). In particular, if the mobile communication terminal could act only as measurement value pick-up which subsequently transmits the measured values to the mobile radio base station in which other calculations and/or comparisons are then performed for determining distance.

As well, a measurement value pick-up set up at a known distance from the transmitting site could supply measurement values by which initial phase relation at the transmitting site can be determined. The measurement value pick up can also be a mobile communication terminal with known location data.

As well, the method can be arranged in such a manner that, with reference to one mobile radio base station, more than two carrier frequencies are used for determining the initial phase relation of the measurement phase relation, respectively, in order to restrict ambiguities or enhance the accuracy of the method.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

This is particularly applicable since electronic components such as receive mixers, frequency converters, phase comparison circuits and oscillators with short-time stability for generating and determining frequency and phase differences are known to the expert. Similarly, the corresponding application methods or intended uses are known to the expert.

In the respective transmitter (mobile radio base station or mobile communication terminal), reference frequency signals are derived from the main oscillator of the transmitter and supplied to one (or more) frequency converters. From this, this frequency converter derives first and second carrier frequency signals with the predetermined frequency offsets. Before the transmission, associated initial phase relations between first and second carrier frequency signals are determined in a phase detector circuit.

In the reverse manner, the frequency of the first carrier frequency signal is converted to the frequency of the second carrier frequency signal or conversely in the respective receiver (mobile communication terminal or mobile radio base station) with a frequency converter and then the measured phase relations of the received first carrier frequency signals with respect to the received second carrier frequency signals are determined in a phase comparison circuit and output for further evaluation.

Depending on configuration, this method quoted by way of example can be formed by a multi-stage frequency conversion and applied sequentially in time or in parallel for one carrier frequency signal or all carrier frequency signals. A known variation of this method is also a comparison with an internal system reference signal. Here, too, the methods quoted for measuring phase differences between carrier frequency signals are only mentioned by way of example without restricting the disclosed method. During a conversion of the method, the expert will use the measuring technology which appears to be most advantageous for his target system given the respective conditions.

The method is not restricted to the application in technical radio systems of the GSM standard, either, but can also be used in technical radio systems which, instead of the GSM standard, use other standards in which, however, the communication between partners is based on frequency division multiplex methods and time division multiplex methods, mentioning the UMTS by way of example.

If, however, apart from the assigned channel patterns, other frequency bands are available, individual or all carrier frequency signals can also be sent out and evaluated outside the frequency domains assigned to the radio standards listed above.

1-11. (canceled)

12. A method having parameters for determining a distance of a mobile communication terminal from a first mobile radio base station in a mobile radio network, comprising:
calculating a first distance value from a timing advance value; and
calculating a multi-valued second distance value more accurate than the first distance value, by using parameters including a frequency offset between a first carrier frequency signal and a second carrier frequency signal, an initial phase relation at a transmitting site, of the first carrier frequency signal with respect to the second carrier frequency signal, and a measured phase relation at a receiving site, of the first carrier frequency signal with respect to the second carrier frequency signal.

13. The method as claimed in claim 12, wherein the first distance value and the second distance value are calculated and/or compared in the mobile communication terminal.

14. The method as claimed in claim 12, wherein the timing advance value and the initial phase relation are signaled to the mobile communication terminal by the first mobile radio base station, and the measured phase relation is determined in the mobile communication terminal.

15. The method as claimed in claim 12, wherein the initial phase relation is determined by the mobile communication terminal, the measured phase relation is determined in the first mobile radio base station, and the timing advance value and the measured phase relation are signaled to the mobile communication terminal by the first mobile radio base station.

16. The method as claimed in claim 12, wherein the first distance value and the second distance value are calculated and/or compared in a network-side component of the mobile radio network.

17. The method as claimed in claim 16, wherein the first distance value, the second distance value or the parameters from which the second distance value is calculated is signaled to the mobile communication terminal by the first mobile radio base station.

18. The method as claimed in claim 12, wherein other mobile radio base stations are used to calculate other timing advance values, other frequency offsets, other initial phase relations, other measured phase relations and other first and second distance values, are used to determine distances to the respective further mobile radio base stations.

19. The method as claimed in claim 12, wherein the first distance value and the second distance value are combined with location data related to the first mobile radio base station for determining a location of the mobile communication terminal.

20. The method as claimed in claim 19, wherein the location is combined with stored geographic data and the location of the mobile communication terminal is displayed on a map on a display unit of the mobile communication terminal.

21. The method as claimed in claim 19, wherein the location is combined with data from service providers in order to provide at least one of rescue services, motion profiles, position-related advertising and position-related news.

22. The method as claimed in claim 12, wherein the first distance value and the second distance value are calculated and compared in the mobile communication terminal.

23. The method as claimed in claim 22, wherein the timing advance value and the initial phase relation are signaled to the mobile communication terminal by the first mobile radio base station, and
the measured phase relation is determined in the mobile communication terminal.

24. The method as claimed in claim 22, wherein
the initial phase relation is determined by the mobile communication terminal,
the measured phase relation is determined in the first mobile radio base station, and
the timing advance value and the measured phase relation are signaled to the mobile communication terminal by the first mobile radio base station.

25. The method as claimed in claim 12, wherein the first distance value and the second distance value are calculated and compared in a network-side component of the mobile radio network.

26. The method as claimed in claim 25, wherein the first distance value, the second distance value or the parameters from which the second distance value is calculated is signaled to the mobile communication terminal by the first mobile radio base station.

27. The method as claimed in claim 26, wherein other mobile radio base stations are used to calculate other timing advance values, other frequency offsets, other initial phase relations, other measured phase relations and other first and second distance values, are used to determine distances to the respective further mobile radio base stations.

28. The method as claimed in claim 27, wherein the first distance value and the second distance value are combined with location data related to the first mobile radio base station for determining a location of the mobile communication terminal.

29. The method as claimed in claim 28, wherein the location is combined with stored geographic data and the location of the mobile communication terminal is displayed on a map on a display unit of the mobile communication terminal.

30. The method as claimed in claim 29, wherein the location is combined with data from service providers in order to provide at least one of rescue services, motion profiles, position-related advertising and position-related news.

31. A mobile communication terminal to determine a distance of a mobile communication terminal from a first mobile radio base station in a mobile radio network, comprising:
a first calculation unit to calculate a first distance value from a timing advance value; and
a second calculation unit to calculate a multi-valued second distance value more accurate than the first distance value, by using parameters including a frequency offset between a first carrier frequency signal and a second carrier frequency signal, an initial phase relation at a transmitting site, of the first carrier frequency signal with respect to the second carrier frequency signal, and a measured phase relation at a receiving site, of the first carrier frequency signal with respect to the second carrier frequency signal.
